(19) United States
(12) Patent Application Publication
(10) Pub. No.: US 2011/0164213 A1
(43) Pub. Date: Jul. 7, 2011

(54) ALIGNMENT FILM, ALIGNMENT FILM MATERIAL, LIQUID CRYSTAL DISPLAY DEVICE COMPRISING ALIGNMENT FILM, AND METHOD FOR MANUFACTURING SAME

(76) Inventors: Yohei Nakanishi, Osaka (JP); Masanobu Mizusaki, Osaka (JP)

(21) Appl. No.: 13/061,809

(22) PCT Filed: Aug. 28, 2009
(86) PCT No.: PCT/JP2009/004204

§ 371 Date: Mar. 2, 2011

(30) Foreign Application Priority Data
Sep. 3, 2008 (JP) 2008-225913

(51) Int. Cl. G02F 1/1337; B05D 5/12; B05D 3/06; C08L 39/04

(52) U.S. Cl. 349/129; 428/1.26; 427/58; 427/553; 525/205

(57) ABSTRACT

An alignment film (100) according to the present invention contains polyimide (102) and a polyvinyl compound (104), the polyvinyl compound (104) containing a polymerization product of a polyfunctional monomer having a plurality of vinyl groups. Preferably, each of the plurality of vinyl groups of the polyfunctional monomer is a part of a methacrylate group or an acrylate group. Preferably, the polyfunctional monomer has two or more directly-bonded ring structures or one or more condensed ring structures between the plurality of vinyl groups. Preferably, both of the polyimide (102) and the polyvinyl compound (104) are present on the surface and in the interior.

### TECHNICAL FIELD

The present invention relates to an alignment film, an alignment film material, and a liquid crystal display device having the alignment film, as well as production methods thereof.

### BACKGROUND ART

Liquid crystal display devices are used not only as small-sized display devices, e.g., the display sections of mobile phones, but also as large-sized television sets. Liquid crystal display devices of the TN (Twisted Nematic) mode, which have often been used conventionally, have relatively narrow viewing angles. In recent years, however, liquid crystal display devices with wide viewing angles have been produced, e.g., the IPS (In-Plane Switching) mode and the VA (Vertical Alignment) mode. Among such modes with wide viewing angles, the VA mode is adopted in a large number of liquid crystal display devices because of an ability to realize a high contrast ratio. Alignment films in generic VA-mode liquid crystal display devices are made of polyimide, which has advantages in terms of thermal resistance, solvent resistance, hygroscopicity, and so on.

As one kind of VA mode, the MVA (Multi-domain Vertical Alignment) mode is known, under which a plurality of liquid crystal domains are created in one pixel region. An MVA-mode liquid crystal display device includes alignment regulating structures provided on the liquid-crystal-layer side of at least one of a pair of opposing substrates, between which a vertical-alignment type liquid crystal layer is interposed. The alignment regulating structures may be linear slits (apertures) or ribs (protruding structures) that are provided on electrodes, for example. The alignment regulating structures provide alignment regulating forces from one side or both sides of the liquid crystal layer, thus creating a plurality of liquid crystal domains (typically four liquid crystal domains) with different alignment directions, whereby the viewing angle characteristics are improved.

As another kind of VA mode, the CPA (Continuous Pinwheel Alignment) mode is also known. In a generic liquid crystal display device of the CPA mode, pixel electrodes of a highly symmetrical shape are provided, and on a counter electrode, protrusions are provided corresponding to the centers of liquid crystal domains. These protrusions are also referred to as rivets. When a voltage is applied, in accordance with an oblique electric field which is created with the counter electrode and a highly symmetrical pixel electrode, liquid crystal molecules take an inclined alignment of a radial shape. Moreover, the inclined alignment of the liquid crystal molecules are stabilized due to the alignment regulating forces of side slopes of the rivets. Thus, the liquid crystal molecules in one pixel are aligned in a radial shape, thereby improving the viewing angle characteristics.

Unlike in TN-mode liquid crystal display devices in which the pretilt direction of liquid crystal molecules is defined by an alignment film, alignment regulating forces in an MVA-mode liquid crystal display device are applied to the liquid crystal molecules by linear slits or ribs. Therefore, depending on distances from the slits and ribs, the alignment regulating forces for the liquid crystal molecules within a pixel region will differ, thus resulting in differing response speeds of the liquid crystal molecules within the pixel. Similarly, also in the CPA mode, the response speeds of the liquid crystal molecules will differ within the pixel, and the differences in response speed will become more outstanding as the pixel electrodes increase in size. Furthermore, in a VA-mode liquid crystal display device, the light transmittance in the regions in which slits, ribs, or rivets are provided is low, thus making it difficult to realize a high luminance.

In order to avoid the above problems, use of an alignment film for applying alignment regulating forces to liquid crystal molecules in a VA-mode liquid crystal display device is also known, such that the liquid crystal molecules will tilt from the normal direction of a principal face of the alignment film in the absence of an applied voltage (see, for example, Patent Documents 1 and 2).

In Patent Document 1, the alignment film is subjected to an alignment treatment such as rubbing. The alignment film aligns the liquid crystal molecules so that the liquid crystal molecules will be aligned with a tilt from the normal direction of its principal face even in the absence of an applied voltage, whereby an improved response speed is realized. Furthermore, since the alignment film defines the pretilt azimuth of liquid crystal molecules so that the liquid crystal molecules within one pixel will be symmetrically aligned, the viewing angle characteristics are improved. In a liquid crystal display device disclosed in Patent Document 1, four liquid crystal domains are formed in a liquid crystal layer in accordance with a combination of two alignment regions of a first alignment film and two alignment regions of a second alignment film, whereby a wide viewing angle is realized.

In Patent Document 2, by obliquely radiating light onto an alignment film having a photoreactive functional group as a side chain, a pretilt is conferred so that the liquid crystal molecules will be inclined from the normal direction of a principal face of the alignment film in the absence of an applied voltage. An alignment film to which a pretilt is conferred through such a photo-alignment treatment may also be referred to as a photo-alignment film. In the photo-alignment film disclosed in Patent Document 2, fluctuations in the pretilt angle are controlled to 1° or less, by using an alignment film material which includes a bonded structure of photosensitive groups.

### CITATION LIST

### Patent Literature

[Patent Document 1] Japanese Laid-Open Patent Publication No. 11-352486
[Patent Document 2] The pamphlet of International Publication No. 2006/121220

### SUMMARY OF INVENTION

### Technical Problem

Generally speaking, when a liquid crystal display device keeps displaying the same pattern for a long time, the previous pattern may remain even after the displayed image is changed. Such a phenomenon is also called image sticking. For example, after displaying white in a partial region of the screen and black in another region for a long time, if the entire liquid crystal panel is caused to display the same intermediate gray scale level, the region previously displaying white may appear slightly brighter than the region previously displaying black.

One cause of such image sticking is charge accumulation. The amount of charge accumulated in the region which was displaying black is different from the amount of charge accumulated in the region which was displaying white, and an electric field occurs because impurity ions in the liquid crystal accumulate at the interface between the alignment film and the liquid crystal layer. Therefore, when entirely switched to the same gray scale level, different voltages are applied across the layers of liquid crystal in the respective regions which were displaying white and black, thus being perceived as image sticking.

Note that image sticking caused by such charge accumulation can be somewhat suppressed by applying voltages of inverted polarities to the respective pixels. Therefore, an image sticking caused by charge accumulation is also called DC image sticking. The driving which involves applying voltages of inverted polarities for the sake of suppressing DC image sticking is also called polarity inversion driving. In actuality, even with polarity inversion driving, it is difficult to apply voltages of completely symmetric polarities and thus a resultant image sticking may be perceived as flickering.

Moreover, image sticking will also occur when minute changes in the pretilt angle occur. When the pretilt angle changes, the V-T characteristics are affected, and thus the transmittance will vary even if the same voltage is applied. Since the applied voltage when displaying white is different from the applied voltage when displaying black, the amount of change in the pretilt angle will vary depending on the applied voltage. When later entirely switched to the same gray scale level, image sticking may be perceived due to changes in the pretilt angle. Such image sticking cannot be suppressed even by performing polarity inversion driving, and is also called AC image sticking.

The present invention has been made in view of the above problems, and an objective thereof is to provide an alignment film which suppresses image sticking caused by changes in the pretilt angle, an alignment film material for forming the aforementioned alignment film, and a liquid crystal display device having the alignment film, as well as production methods thereof.

### Solution to Problem

An alignment film according to the present invention is an alignment film comprising polyimide and a polyvinyl compound, wherein, the polyvinyl compound contains a polymerization product of a polyfunctional monomer having a plurality of vinyl groups; and the polyfunctional monomer is represented by general formula (1) P1-A1-(Z1-A2)n-P2 (in general formula (1), P1 and P2 are, independently, acrylate, methacrylate, acrylamide or methacrylamide; A1 and A2 represent, independently, 1,4-phenylene, 1,4-cyclohexane or 2,5-thiophene, or naphthalene-2,6-diyl, anthracene-2,7-diyl, anthracene-1,8-diyl, anthracene-2,6-diyl or anthracene-1,5-diyl; and Z1 is a —COO— group, a —OCO— group, a —O— group, a —CONH— group or a single bond, where n is 0 or 1).

In one embodiment, each of plurality of vinyl groups of the polyfunctional monomer is a part of a methacrylate group or an acrylate group.

In one embodiment, the polyfunctional monomer has two or more directly-bonded ring structures or one or more condensed ring structures between the plurality of vinyl groups.

In one embodiment, both of the polyimide and the polyvinyl compound are present on a surface and in an interior thereof.

In one embodiment, a concentration of the polyvinyl compound at the surface is higher than a concentration of the polyvinyl compound in the interior.

In one embodiment, the alignment film is a photo-alignment film.

In one embodiment, the polyimide has a side chain containing a photoreactive functional group.

In one embodiment, the photoreactive functional group includes a cinnamate group.

A liquid crystal display device according to the present invention is a liquid crystal display device comprising an active matrix substrate, a counter substrate, and a liquid crystal layer provided between the active matrix substrate and the counter substrate, wherein at least one of the active matrix substrate and the counter substrate comprises the aforementioned alignment film.

In one embodiment, the alignment film regulates liquid crystal molecules in the liquid crystal layer so that the liquid crystal molecules are inclined with respect to a normal direction of a principal face of the alignment film in the absence of an applied voltage.

In one embodiment, the liquid crystal display device has a plurality of pixels; and in each of the plurality of pixels, the liquid crystal layer has a plurality of liquid crystal domains having respectively different reference alignment azimuths.

In one embodiment, the plurality of liquid crystal domains are four liquid crystal domains.

A method of producing an alignment film according to the present invention comprises the steps of: providing an alignment film material containing a mixture of a polyimide precursor and a polyfunctional monomer having a plurality of vinyl groups; and forming polyimide from the polyimide precursor, and forming a polyvinyl compound from the polyfunctional monomer.

In one embodiment, the step of forming the polyvinyl compound comprises a step of polymerizing the polyfunctional monomer.

In one embodiment, in the step of providing the alignment film material, the polyfunctional monomer has two or more directly-bonded ring structures or one or more condensed ring structures between the plurality of vinyl groups, and a concentration of the polyfunctional monomer on the basis of the alignment film material is in the range of no less than 2 wt % and no more than 50 wt %.

In one embodiment, the step of forming the polyimide and the polyvinyl compound comprises a step of performing a heat treatment.

In one embodiment, the step of performing a heat treatment comprises the steps of: performing a first heat treatment; and after performing the first heat treatment, performing a second heat treatment at a higher temperature than that of the first heat treatment.

A method of producing a liquid crystal display device according to the present invention comprises the steps of: forming an active matrix substrate and a counter substrate; and forming a liquid crystal layer between the active matrix substrate and the counter substrate, wherein, the step of forming the active matrix substrate and the counter substrate comprises the steps of: providing a first transparent substrate having a pixel electrode thereon and a second transparent substrate having a counter electrode thereon; and producing an alignment film on at least one of the pixel electrode and the counter electrode according to the above production method.

In one embodiment, in the step of forming the liquid crystal layer, the alignment film, the alignment film regulates liquid crystal molecules in the liquid crystal layer so that the liquid crystal molecules are inclined with respect to a normal direction of a principal face of the alignment film in the absence of an applied voltage.

In one embodiment, the step of forming the active matrix substrate and the counter substrate further comprises a step of performing an alignment treatment for the alignment film.

In one embodiment, the step of performing the alignment treatment further comprises a step of irradiating the alignment film with light.

In one embodiment, the light has a wavelength in the range of no less than 250 nm and no more than 400 nm.

In one embodiment, the step of performing the alignment treatment comprises a step of radiating the light from a direction which is inclined by no less than 5° and no more than 85° with respect to a normal direction of a principal face of the alignment film.

In one embodiment, the light is unpolarized light.

In one embodiment, the light is linearly polarized light, elliptically polarized light, or circularly polarized light.

In one embodiment, the step of performing the alignment treatment comprises a step of performing a rubbing treatment for the alignment film.

An alignment film material according to the present invention comprises a polyimide precursor and a polyfunctional monomer having a plurality of vinyl groups.

### ADVANTAGEOUS EFFECTS OF INVENTION

According to the present invention, there are provided: an alignment film which suppresses image sticking caused by changes in the pretilt angle, an alignment film material, a liquid crystal display device having the alignment film, and production methods thereof.

### BRIEF DESCRIPTION OF DRAWINGS

FIG. 1 A schematic plan view of an embodiment of an alignment film according to the present invention.

FIG. 2 (a) is a schematic diagram of an embodiment of a liquid crystal display device according to the present invention; and (b) is a schematic diagram of a liquid crystal panel of the liquid crystal display device of the present embodiment.

FIG. 3 (a) to (c) are schematic diagrams each illustrating a production method of the liquid crystal display device of the present embodiment.

FIG. 4 (a) is a schematic diagram of an alignment film of the liquid crystal display device of the present embodiment; (b) is a schematic diagram of the alignment film; and (c) is a schematic diagram showing alignment directions of liquid crystal molecules in the centers of liquid crystal domains.

FIG. 5 (a) is a schematic diagram showing an alignment state of liquid crystal molecules in a liquid crystal display device of Example 1-1; and (b) is a schematic diagram showing alignment treatment directions for the first and second alignment films as viewed from the viewer's side.

FIG. 6 A schematic diagram showing alignment treatment directions for the first and second alignment films as viewed from the viewer's side, in a liquid crystal display device of Example 3.

FIG. 7 A schematic diagram showing alignment treatment directions for the first and second alignment films as viewed from the viewer's side, in a liquid crystal display device of Example 4.

### DESCRIPTION OF EMBODIMENTS

Hereinafter, with reference to the drawings, an embodiment of an alignment film, alignment film material, and liquid crystal display device having the alignment film according to the present invention will be described.

FIG. 1 shows a schematic diagram of an alignment film 100 of the present embodiment. The alignment film 100 contains polyimide 102 and a polyvinyl compound 104. In at least a partial surface region of the alignment film 100, the main chains of the polyimide 102 align essentially in one direction. The polyimide 102 is formed by imidizing a polyimide precursor.

The alignment film 100 of the present embodiment contains not only the polyimide 102 but also the polyvinyl compound 104, the polyvinyl compound 104 containing a polymerization product of a polyfunctional monomer. The polyvinyl compound 104 is formed through polymerization of a polyfunctional monomer having a plurality of vinyl groups, and the polyfunctional monomer is biphenyldimethacrylate or biphenyl diacrylate, for example. Thus, the vinyl groups of the polyfunctional monomer are parts of methacrylate groups or acrylate groups, for example.

The polyfunctional monomer is represented by general formula (1) P1-A1-(Z1-A2)n-P2 (in general formula (1), P1 and P2 are, independently, acrylate, methacrylate, acrylamide or methacrylamide; A1 and A2 represent, independently, 1,4-phenylene, 1,4-cyclohexane or 2,5-thiophene, or naphthalene-2,6-diyl, anthracene-2,7-diyl, anthracene-1,8-diyl, anthracene-2,6-diyl or anthracene-1,5-diyl; and Z1 is a —COO— group, a —OCO— group, a —O— group, a —CONH— group or a single bond, where n is 0 or 1). Moreover, at least one of A1 and A2 may be substituted by one fluorine group.

Since the polyfunctional monomer has a plurality of vinyl groups, the polyvinyl compound 104 which is formed through polymerization of the polyfunctional monomer has a three-dimensional network structure. Moreover, this polyfunctional monomer has two or more directly-bonded ring structures or one or more condensed ring structures between the plurality of vinyl groups, and has a low degree of freedom with respect to deformation, such that the polyvinyl compound 104 is unlikely to deform under stress. Thus, by containing the polyvinyl compound 104, the alignment film 100 is structurally stabilized, whereby fluctuations of the alignment characteristics are suppressed.

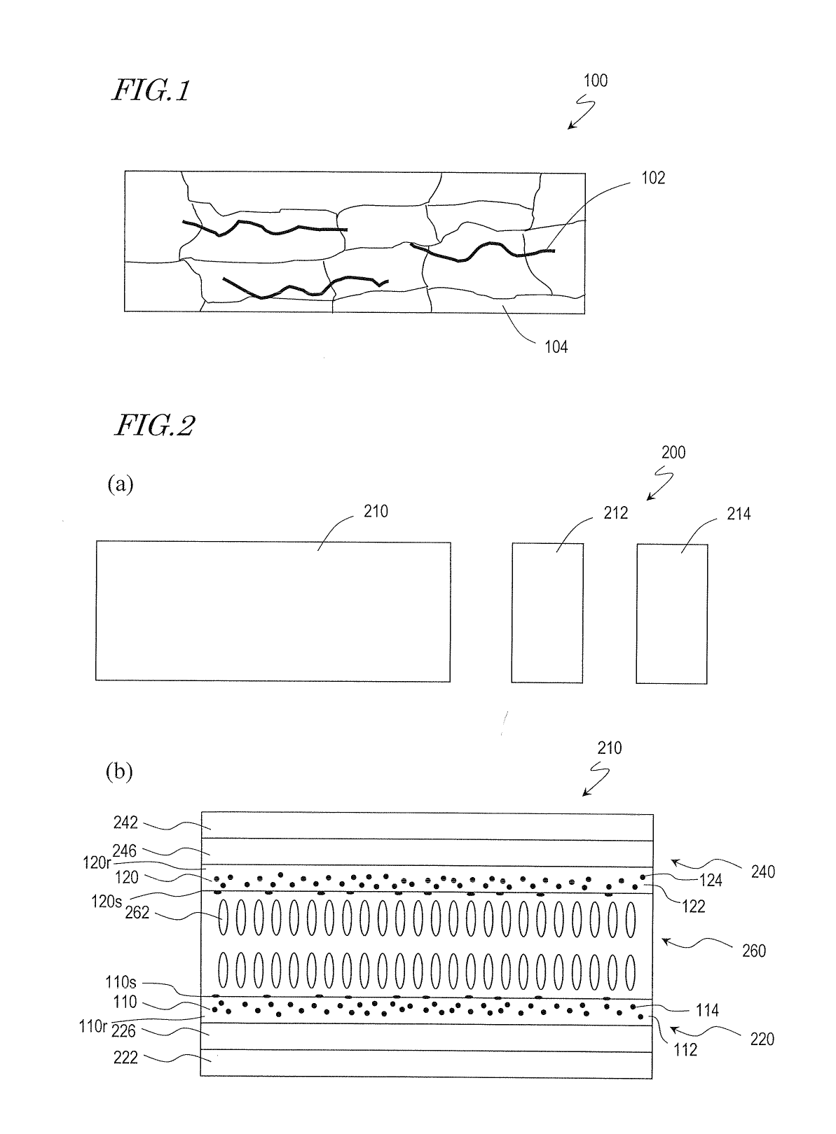

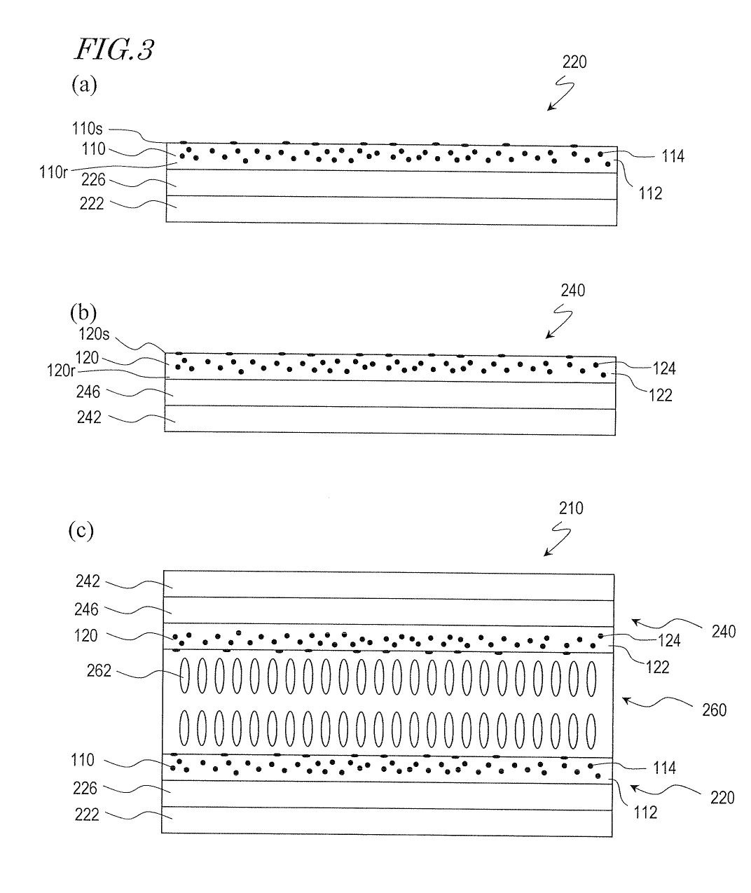

Hereinafter, with reference to FIG. 2, a liquid crystal display device 200 having alignment films 110 and 120 according to the present embodiment will be described. FIG. 2(a) shows a schematic diagram of the liquid crystal display device 200. The liquid crystal display device 200 includes a liquid crystal panel 210, a driving circuit 212 for driving the liquid crystal panel 210, and a control circuit 214 for controlling the driving circuit 212. Although not shown, the liquid crystal display device 200 may include a backlight as necessary.

As shown in FIG. 2(b), the liquid crystal panel 210 includes an active matrix substrate 220 having the first alignment film 110, a counter substrate 240 having the second alignment film 120, and a liquid crystal layer 260 provided between the active matrix substrate 220 and the counter substrate 240. The active matrix substrate 220 further includes a first transparent substrate 222 and pixel electrodes 226, such that the first alignment film 110 covers the pixel electrodes 226. Moreover, the counter substrate 240 further includes a second transparent substrate 242 and a counter electrode 246, such that the second alignment film 120 covers the counter electrode 246. The liquid crystal layer 260 is interposed between the active matrix substrate 220 and the counter substrate 240.

The liquid crystal display device 200 includes pixels composing a matrix of a plurality of rows and a plurality of columns. On the active matrix substrate 220, at least one switching element (e.g., thin film transistor (Thin Film Transistor: TFT)) (not shown in the figure) is provided for each pixel, and the active matrix substrate 220 is also referred to a TFT substrate. In the present specification, a “pixel” refers to the smallest unit that expresses a specific gray scale level in displaying; in the case of multicolor displaying, a “pixel” corresponds to a unit that expresses a gray scale level of each of R, G, and B, for example, and is also referred to as a dot. A combination of an R pixel, a G pixel, and a B pixel composes a single color displaying pixel. A “pixel region” refers to a region of the liquid crystal panel 210 that corresponds to a “pixel” in displaying.

Although not shown, a polarizer is provided on each of the active matrix substrate 220 and the counter substrate 240. Therefore, the two polarizers are disposed so as to oppose each other with the liquid crystal layer 260 interposed therebetween. The transmission axes (polarization axes) of the two polarizers are positioned so as to be orthogonal to each other, such that one of them extends along the horizontal direction (row direction), whereas the other extends along the vertical direction (column direction).

The first alignment film 110 contains polyimide 112 and a polyvinyl compound 114, and the polyvinyl compound 114 contains a polymerization product of a polyfunctional monomer having a plurality of vinyl groups. The second alignment film 120 contains polyimide 122 and a polyvinyl compound 124, and the polyvinyl compound 124 contains a polymerization product of a polyfunctional monomer having a plurality of vinyl groups. The first alignment film 110 and second alignment film 120 as such are formed from an alignment film material which contains a polyimide precursor and a polyfunctional monomer having a plurality of vinyl groups. The polyimide 112, 122 is formed by imidizing the polyimide precursor. The polyvinyl compound 114, 124 is formed through polymerization of the polyfunctional monomer. The polymerization is performed by applying heat or light to the polyfunctional monomer. For example, after applying an alignment film material containing a mixture of a polyimide precursor and a polyfunctional monomer onto the pixel electrodes 226 and the counter electrode 246, a heat treatment is performed to evaporate the solvent, whereby the first and second alignment films 110 and 120 containing the polyimide 112, 122 and the polyvinyl compound 114, 124 is formed. The heat treatment is performed twice at different temperatures, for example.

The liquid crystal layer 260 contains a nematic liquid crystal material (liquid crystal molecules 262) having negative dielectric anisotropy. The first alignment film 110 and the second alignment film 120 are each treated so that the pretilt angle of the liquid crystal molecules 262 is less than 90° with respect to the surface of the vertical alignment film. The pretilt angle of the liquid crystal molecules 262 is an angle between principal faces of the first alignment film 110 and the second alignment film 120 and the major axis of each liquid crystal molecule 262 that is regulated in a pretilt direction.

Although the liquid crystal layer 260 is of a vertical-alignment type, due to the polyimide 112, 122, the liquid crystal molecules 262 in its neighborhood are slightly inclined from the normal directions of the principal faces of the first and second alignment films 110 and 120. The pretilt angle is within a range from 85° to 89.7°, for example. The side chain of the polyimide 112, 122 defines the pretilt direction of the liquid crystal molecules 262. In the following description, this component may also be referred to as a pretilt-angle-exhibiting component. By irradiating the first or second alignment film 110 or 120 with light from a direction which is oblique to the normal direction of its principal face, an alignment regulating force is applied to the polyimide 112, 122 such that the liquid crystal molecules 262 are aligned so as to be inclined from the normal directions of the principal faces of the first and second alignment films 110 and 120 in the absence of an applied voltage. Such a treatment is also referred to as a photo-alignment treatment. Since a photo-alignment treatment is performed without involving any contact, static electricity will not occur due to friction as in a rubbing treatment, and thus the production yield can be improved.

Moreover, the pretilt azimuth of the liquid crystal molecules 262 introduced by the first alignment film 110 is different from the pretilt azimuth of the liquid crystal molecules 262 introduced by the second alignment film 120. For example, the pretilt azimuth of the liquid crystal molecules 262 introduced by the first alignment film 110 intersects, at 90°, the pretilt azimuth of the liquid crystal molecules 262 introduced by the second alignment film 120. Herein, the liquid crystal layer 260 does not include any chiral agent, so that, when a voltage is applied across the liquid crystal layer 260, the liquid crystal molecules 262 within the liquid crystal layer 260 take a twist alignment in accordance with the alignment regulating forces from the first and second alignment films 110 and 120. However, a chiral agent may be added to the liquid crystal layer 260 as necessary. In combination with polarizers which are placed in crossed Nicols, the liquid crystal layer 260 performs displaying in a normally black mode.

Moreover, each of the first and second alignment films 110 and 120 may have a plurality of alignment regions for each pixel. For example, a portion of the first alignment film 110 may be masked, and after a predetermined region of the first alignment film 110 is irradiated with light from a certain direction, another region which was not irradiated with light may be irradiated with light from a different direction. Furthermore, a similar photo-alignment treatment is performed also for the second alignment film 120. In this manner, regions that confer different alignment regulating forces can be formed in each of the first and second alignment films 110 and 120.

Since the polyvinyl compound 114, 124 of the first and second alignment films 110 and 120 contains a polymerization product resulting from polymerization of a polyfunctional monomer having a plurality of vinyl groups, the first and second alignment films 110 and 120 are structurally stabilized, whereby changes in the alignment function are suppressed, and the pretilt angle of the liquid crystal molecules 262 in the liquid crystal layer 260 is maintained. Note that, if the polyvinyl compound contained in the alignment films were a polymerization product resulting from polymerization of a monofunctional monomer, changes in the alignment function would not be adequately suppressed because the polymerization product to be formed in this case, i.e., a long linear polymer, is likely to be deformed. Moreover, since the alignment films 110 and 120 contain the polyvinyl compound 114, 124, which contains the polyimide 112, 122 and a polymerization product of a polyfunctional monomer, thermal resistance, solvent resistance, hygroscopicity, and other characteristics of the alignment films 110 and 120 are substantially non-inferior to those of a commonly-used alignment film formed of polyimide.

Both of the polyimide 112 and the polyvinyl compound 114 are present in an internal region 110r and a surface region 110s of the first alignment film 110. Moreover, both of the polyimide 122 and the polyvinyl compound 124 are present in an internal region 120r and a surface region 120s of the second alignment film 120. However, the concentration of the polyvinyl compound 114, 124 in the surface region 110s and 120s of the first and second alignment films 110 and 120 is higher than that in the internal regions 110r and 120r of the first and second alignment films 110 and 120. The concentration of the polyvinyl compound 114, 124 is measured by, for example, time of flight-secondary ion mass spectrometry (TOF-SIMS) or X-ray photoelectron spectroscopy (XPS). In the case of XPS, for example, an apparatus manufactured by ULVAC-PHI, INCORPORATED may be used to analyze the atoms in the depth direction while etching with C60.

As a technique of suppressing image sticking caused by changes in the pretilt angle, Polymer Sustained Alignment Technology (hereinafter referred to as “PSA technique”) is known. In the PSA technique, the pretilt direction of the liquid crystal molecules is controlled by a polymerization product that is generated by irradiating the polymerizable compound with an active energy ray (e.g., ultraviolet light) while applying a voltage across a liquid crystal layer in which a small amount of polymerizable compound (e.g., a photopolymerizable monomer) is mixed.

Now, differences between an alignment sustaining layer which is formed by a generic PSA technique and the polyvinyl compound 114, 124 in the alignment films 110 and 120 of the liquid crystal display device 200 of the present embodiment will be described.

In the PSA technique, the alignment sustaining layer exists on the alignment film, and when the liquid crystal panel is disassembled to analyze the surface of the active matrix substrate or the counter substrate by TOF-SIMS or XPS, ions or atoms derived from the polymerization product component will be detected at the outermost surface of the substrate. On the other hand, in the display device 200 of the present embodiment, the polyvinyl compound 114, 124 is contained in the alignment films 110 and 120, and when the liquid crystal panel is disassembled to similarly analyze the surface of the active matrix substrate 220 or the counter substrate 240, not only ions or atoms derived from the polyvinyl compound 114, 124 but also ions or atoms derived from the polyimide 112, 122 component will be detected, indicative that the polyimide 112 and the polyvinyl compound 114 are present at the surface of the active matrix substrate 220, and also that the polyimide 122 and the polyvinyl compound 124 are present at the surface of the counter substrate 240.

Moreover, in the PSA technique, polymerization product is formed through light irradiation after producing a liquid crystal panel having an alignment film, whereas in the liquid crystal display device 200 of the present embodiment, the polyvinyl compound 114, 124 is contained in the first and second alignment films 110 and 120, and the polyvinyl compound 114, 124 is formed before the active matrix substrate 220 and the counter substrate 240 are attached together. Therefore, even if the active matrix substrate 220 and the counter substrate 240 is to be attached together in a different place from the place where the active matrix substrate 220 and the counter substrate 240 were produced, there is no need to effect polymer formation at the place where they are attached together, thus facilitating the production of the liquid crystal display device 200.

In the liquid crystal display device 200 of the present embodiment, as described above, the alignment films 110 and 120 contain the polyvinyl compound 114, 124, which fixes the pretilt direction of the liquid crystal molecules 262. This is presumably because the polyvinyl compound 114, 124 suppresses deformation of the pretilt-angle-exhibiting component, whereby the alignment direction of the liquid crystal molecules 262 introduced by the polyimide 112, 122 is maintained in a direction which is essentially vertical to the principal faces of the alignment films 110 and 120. Moreover, the polyvinyl compound 114, 124 stabilizes the impurities and the like which have occurred due to damage during the alignment treatment, thus suppressing generation of impurity ions and occurrence of image sticking.

The polyimide 112, 122 has, for example, a side chain which contains a cinnamate group as a photoreactive functional group, such that a dimerization site which is formed through light irradiation is provided on the side chain. Moreover, the side chain may contain a fluorine atom. When the side chain of the polyimide 112, 122 contains a fluorine atom, the aforementioned image sticking is suppressed to a certain extent.

For example, the main chain of the polyimide 112, 122 is represented by the following structural formula.

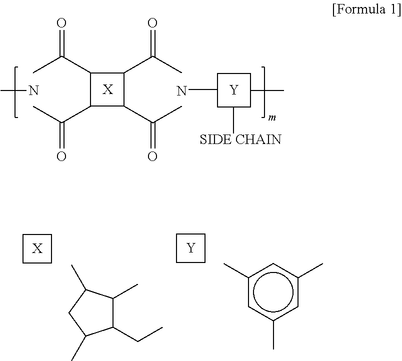

Moreover, the side chain of the polyimide 112, 122 is generally represented by the following structural formula.

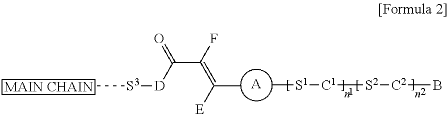

A represents pyrimidine-2,5-diyl, pyridine-2,5-diyl, 2,5-thiophenylene, 2,5-furanylene, 1,4- or 2,6-naphthylene, or phenylene, optionally substituted by a group selected from fluorine, chlorine, and cyano, or by a C₁₋₁₈ cyclic, linear, or branched alkyl residue (which is optionally substituted by one cyano group or one or more halogen atoms, where one or more non-adjacent —CH₂— groups of the alkyl are optionally replaced by a group Q).

B is a linear or branched alkyl residue which is unsubstituted, mono-substituted by cyano or halogen, or poly-substituted by halogen, having 3 to 18 carbon atoms (where one or more non-adjacent CH₂ groups may independently be replaced by a group Q).

C¹ and C² each independently of the other represent an aromatic or alicyclic group (which is unsubstituted or substituted by fluorine, chlorine, cyano, or by a cyclic, linear, or branched alkyl residue (which is unsubstituted, mono-substituted by cyano or halogen, or poly-substituted by halogen, having 1 to 18 carbon atoms and where one or more non-adjacent CH₂ groups may independently be replaced by a group Q)). D represents an oxygen atom or —NR¹— (where R¹ represents a hydrogen atom or lower alkyl).

Moreover, S¹ and S² each independently of the other represent a single covalent bond or a spacer unit. S³ represents a spacer unit.

Q represents a group selected from —O—, —CO—, —CO—O—, —O—CO—, —Si(CH₃)₂—O—Si(CH₃)₂—, —NR¹—, —NR¹—CO—, —CO—NR¹—, —NR¹—CO—O—, —O—CO—NR¹—, —NR¹—CO—NR¹—, —CH═CH—, —C≡C—, and —O—CO—O— (where R¹ represents a hydrogen atom or lower alkyl). E and F each independently of the other represent hydrogen, fluorine, chlorine, cyano, alkyl optionally substituted by fluorine having carbon atoms 1 to 12 (where optionally one or more non-adjacent CH₂ groups are replaced by —O—, —CO—O—, —O—CO— and/or —CH═CH—).

Herein, it is preferable that A includes an aromatic compound; B includes fluorocarbon; D includes at least one or more hydrocarbon groups; and E and F include hydrogen atoms.

More specifically, the side chain of the polyimide 112, 122 is represented by the following structural formula.

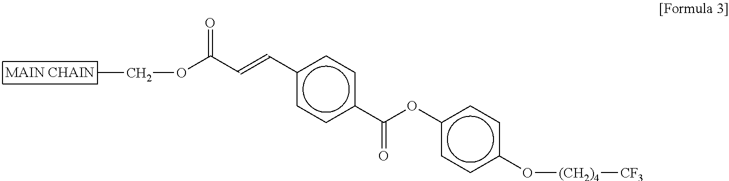

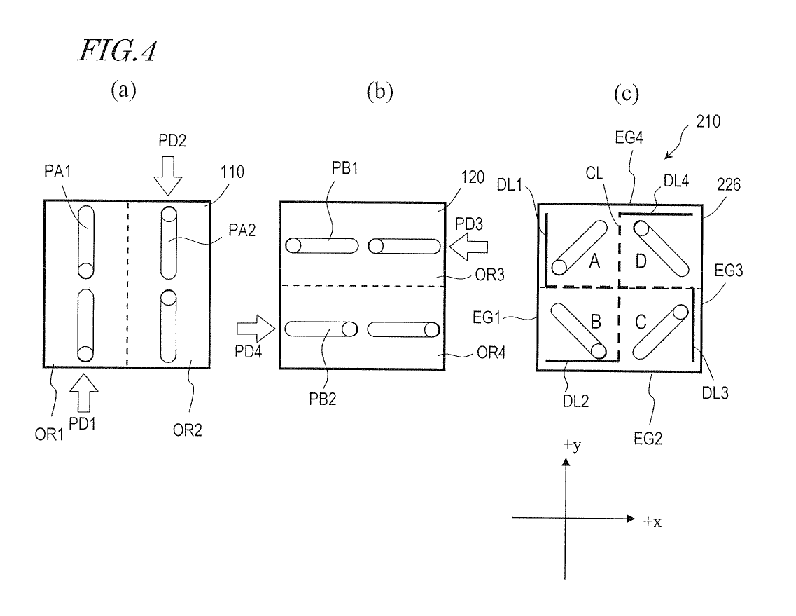

Hereinafter, with reference to FIG. 3, a production method for the liquid crystal display device 200 will be described.

First, as shown in FIG. 3(a), the pixel electrodes 226 are formed on the first transparent substrate 222. Although not shown in FIG. 3(a), TFTs and wiring lines and the like that are connected thereto are provided between the first transparent substrate 222 and the pixel electrodes 226.

Moreover, an alignment film material containing a mixture of a polyimide precursor and a polyfunctional monomer is prepared. The alignment film material is formed by dissolving a polyfunctional monomer in a solvent in which a polyimide precursor is dissolved. The polyfunctional monomer is polymerized upon application of heat or light, thus forming a polymerization product. The polyfunctional monomer has two or more ring structures or one or more condensed ring structures, for example. As the monomer, at least either one of a methacrylate-type monomer and an acrylate-type monomer is used. Moreover, the solvent contains γ-butyrolactone and N-methylpyrrolidone (NMP), for example. The concentration of the polyfunctional monomer on the basis of the alignment film material is no less than 2 wt % and no more than 50 wt %, for example.

This alignment film material is obtained by, for example, after allowing a polyimide precursor (polyamic acid) having a polyamic acid (PAA) type main chain and a side chain which contains a cinnamate group to be dissolved in a solvent, adding biphenyldimethacrylate as the polyfunctional monomer. The structural formula of the main chain of polyamic acid is shown below.

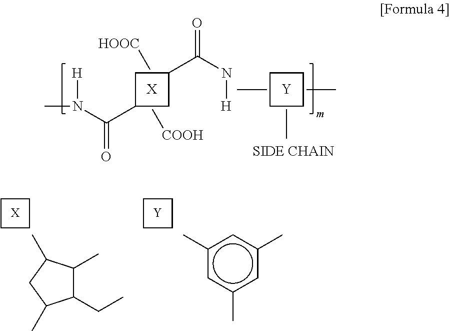

Next, an alignment film material is applied (provided) on the pixel electrodes 226, and a heat treatment is conducted to form the first alignment film 110. As the heat treatment, for example, two heat treatments may be performed at different temperatures. Specifically, after performing a first heat treatment, a second heat treatment is performed at a higher temperature than that of the first heat treatment. The first heat treatment removes most of the solvent so that the alignment film is formed, and the second heat treatment stabilizes the alignment film. The first heat treatment is also referred to as a pre-sinter, and the second heat treatment a full sinter. Through the heat treatment, the polyamic acid is imidized, whereby the polyimide 112 is formed. Also through the heat treatment, the polyfunctional monomer is polymerized, whereby the polyvinyl compound 114 is formed. The first alignment film 110 is formed in this manner. The polyvinyl compound 114 is present in the surface region 110s and the internal region 110r of the first alignment film 110. Herein, the polyimide 112 is also present in the surface region 110s and the internal region 110r of the first alignment film 110.

Next, the first alignment film 110 is subjected to an alignment treatment. The alignment treatment may be performed after the first heat treatment, or after the second heat treatment. For example, the alignment treatment is performed by irradiating the first alignment film 110 with light. For example, light of wavelengths in the range of no less than 250 nm and no more than 400 nm is radiated onto the first alignment film 110 at an irradiation dose of no less than 20 mJ/cm² and no more than 200 mJ/cm², from a direction which is inclined from the normal direction of the principal face of the first alignment film 110. If the irradiation dose increases from 200 mJ/cm², the alignment film may deteriorate so that the voltage holding ratio and the like may be lowered. Moreover, the irradiation angle of light may be in the range of no less than 5° and no more than 85°, and preferably no less than 40° and no more than 60°, from the normal direction of the principal face of the first alignment film 110. Note that, when the irradiation angle is small, it becomes difficult to confer a pretilt angle; when the irradiation angle is too large, it takes more time to confer the same pretilt angle. Moreover, light may be unpolarized light, linearly polarized light, elliptically polarized light, or circularly polarized light. However, linearly polarized light is to be used in the case where a cinnamate group is used as the photoreactive functional group.

As shown in FIG. 3(b), the counter electrode 246 is formed on the second transparent substrate 242. Moreover, an alignment film material is provided. This alignment film material may be similar to that of the first alignment film 110.

Next, the alignment film material is applied on the counter electrode 246, and subjected to a heat treatment, thereby forming the second alignment film 120. As the heat treatment, for example, two heat treatments may be performed at different temperatures. The heat treatment evaporates the solvent so that the polyimide 122 is formed, and polymerizes the polyfunctional monomer so that the polyvinyl compound 124 is formed. Next, the second alignment film 120 formed in this manner is subjected to an alignment treatment. The alignment treatment is performed in a similar manner to the first alignment film 110.

Next, as shown in FIG. 3(c), the active matrix substrate 220 and the counter substrate 240 are placed so that the first alignment film 110 and the second alignment film 120 oppose each other. In the present specification, before formation of the liquid crystal layer, the active matrix substrate and the counter substrate attached together will be referred to as a “vacant panel”.

Next, a liquid crystal material is provided, and the liquid crystal material is introduced between the first alignment film 110 and the second alignment film 120 of the vacant panel, thus forming the liquid crystal layer 260. As described above, the first and second alignment films 110 and 120 have been subjected to an alignment treatment, and thus the liquid crystal molecules 262 are aligned so as to be inclined from the normal directions of the principal faces of the first and second alignment films 110 and 120 even in the absence of an applied voltage. Moreover, the polyvinyl compound 114, 124 maintains the alignment of the liquid crystal molecules 262, whereby image sticking caused by changes in the pretilt angle is suppressed. The liquid crystal panel 210 is produced in this manner. Thereafter, the driving circuit 212 and the control circuit 214 shown in FIG. 2(a) are mounted on the liquid crystal panel 210, whereby the liquid crystal display device 200 is produced.

In the aforementioned PSA technique, a polymerization product is formed under an applied voltage. In the case where ultraviolet for polymer formation purposes is radiated while thus applying a voltage, a complex fabrication apparatus is required in which a device for applying a voltage across the liquid crystal panel and a device for radiating ultraviolet light are integrated. Moreover, since ultraviolet light irradiation is performed after a voltage is applied across the liquid crystal panel for a long time for obtaining a predetermined alignment, this fabrication apparatus needs to be used for a long time. Moreover, when forming the liquid crystal layer of a liquid crystal panel through dropwise application of a liquid crystal material, generally speaking, a plurality of liquid crystal panels are simultaneously produced by using a large-sized mother glass substrate, and thereafter each liquid crystal panel is cut out from the large-sized mother glass substrate. In this case of simultaneously producing a plurality of liquid crystal panels, a design must be adopted such that special wiring lines are formed on the mother glass substrate for allowing a voltage to be simultaneously applied to the plurality of liquid crystal panels.

Moreover, in the case where a liquid crystal panel of a particularly large size is to be produced, it is difficult to uniformly apply a voltage across the liquid crystal layer in the respective pixels. If ultraviolet light irradiation is performed with non-uniform voltages being applied, there will be fluctuations in the pretilt angle.

Moreover, in the case of applying a voltage during polymer formation, ribs, slits, or rivets need to be provided on the pixel electrode and the counter electrode for improved viewing angle characteristics. This will result in an increased number of steps and a decrease in the effective aperture ratio.

On the other hand, in the production method of the present embodiment, no voltage is applied when forming the polyvinyl compound 114, 124. Therefore, the liquid crystal display device 200 can be easily produced without using a complex fabrication apparatus. Moreover, a liquid crystal panel can be easily produced even when producing the liquid crystal layer 260 through dropwise application of a liquid crystal material. Moreover, since it is not necessary to apply a voltage across the liquid crystal layer 260 of all pixels when forming the polyvinyl compound 114, 124, fluctuations in the pretilt angle among liquid crystal molecules 262 can be suppressed. Furthermore, the viewing angle can be improved without providing ribs, slits, or rivets on the pixel electrodes 226 and the counter electrode 246, thus reducing an increase in the number of steps.

Note that slits, ribs, and/or rivets may be provided on the pixel electrodes 226 and the counter electrode 246. Alternatively, slits, ribs, and/or rivets may not be provided on the pixel electrodes 226 and the counter electrode 246, and the liquid crystal molecules 262 may be aligned in accordance with an oblique electric field which is created by a highly-symmetrical pixel electrode 226 and the counter electrode 246. As a result, the alignment regulating force of the liquid crystal molecules 262 under an applied voltage can be further increased.

Although the above description illustrates that the first and second alignment films 110 and 120 each contain the polyvinyl compound 114, 124, the present invention is not limited thereto. Only one of the first and second alignment films 110 and 120 may contain the corresponding polyvinyl compound 114, 124.

Although the above description illustrates that the active matrix substrate 220 and the counter substrate 240 respectively include the first and second alignment films 110 and 120, the present invention is not limited thereto. One of the active matrix substrate 220 and the counter substrate 240 may include the corresponding first or second alignment film 110 or 120.

Although the above description illustrates that polyvinyl compound 114, 124 is formed through a heat treatment, the present invention is not limited thereto. The polyvinyl compound 114, 124 may be formed through light irradiation. For example, in such light irradiation, a light source which mainly emits ultraviolet light (i-line) with a wavelength of 365 nm is suitably used. The irradiation time is about 500 seconds, for example, and the irradiation intensity of light is about 20 mW/cm². In the case where polymerization is effected through light irradiation, the polyfunctional monomer will sufficiently polymerize even if the irradiation intensity of light is 10 mW/cm² or less. The wavelength of light is preferably in the range of no less than 250 nm and no more than 400 nm, and more preferably in the range of no less than 300 nm and no more than 400 nm. However, polymerization will sufficiently occur with light of a wavelength greater than 400 nm. Although polymerization can occur with light of a wavelength of 300 nm or less, the irradiation dose should preferably be as small as possible because decomposition of organic matter will occur with irradiation of deep-ultraviolet with wavelengths near 200 nm.

Although the above description illustrates that a photo-alignment treatment is performed as the alignment treatment, the present invention is not limited thereto. A rubbing treatment may be performed as the alignment treatment.

Moreover, the liquid crystal display device 200 may be of the 4D-RTN (4 Domain-Reverse Twisted Nematic) mode. Hereinafter, a liquid crystal display device of the 4D-RTN mode will be described with reference to FIG. 4.

FIG. 4(a) shows pretilt directions PA1 and PA2 of liquid crystal molecules defined on the alignment film 110 of the active matrix substrate 220, and FIG. 4(b) shows pretilt directions PB1 and PB2 of liquid crystal molecules defined on the alignment film 120 of the counter substrate 240. FIG. 4(c) shows alignment directions of liquid crystal molecules in the centers of liquid crystal domains A to D under an applied voltage, and regions (domain lines) DL1 to DL4 appearing dark due to alignment disorder. Note that the domain lines DL1 to DL4 are not so-called disclination lines.

FIG. 4(a) to FIG. 4(c) schematically show alignment directions of liquid crystal molecules as seen from the viewer side. FIG. 4(a) to FIG. 4(c) indicate that the end portions (essentially circular portions) of the cylindrical liquid crystal molecules are tilted toward the viewer.

As shown in FIG. 4(a), the first alignment film 110 includes a first alignment region OR1 and a second alignment region OR2. The liquid crystal molecules regulated by the first alignment region OR1 are tilted in the −y direction from the normal direction of the principal face of the first alignment film 110, whereas the liquid crystal molecules regulated by the second alignment region OR2 of the first alignment film 110 are tilted in the +y direction from the normal direction of the principal face of the first alignment film 110. Moreover, the boundary between the first alignment region OR1 and the second alignment region OR2 extends in the column direction (y direction), and located in the substantial center along the row direction (x direction) of pixels. Thus, first and second alignment regions OR1 and OR2 of different pretilt azimuths are provided on the first alignment film 110.

Moreover, as shown in FIG. 4(b), the second alignment film 120 includes a third alignment region OR3 and a fourth alignment region OR4. The liquid crystal molecules regulated by the third alignment region OR3 are tilted in the +x direction from the normal direction of the principal face of the second alignment film 120, such that the −x direction end portions of these liquid crystal molecules are pointed toward the front face. The liquid crystal molecules regulated by the fourth alignment region OR4 of the second alignment film 120 are tilted in the −x direction from the normal direction of the principal face of the second alignment film 120, such that the +x direction end portions of these liquid crystal molecules are pointed toward the front face. Thus, the second alignment film 120 includes third and fourth alignment regions OR3 and OR4 with different pretilt azimuths.

An alignment treatment direction corresponds to an azimuth angle component obtained by projecting a direction, which extends toward an alignment region along the major axes of the liquid crystal molecules, onto that alignment region. The alignment treatment directions of the first, second, third, and fourth alignment regions are also referred to as first, second, third, and fourth alignment treatment directions.

The first alignment region OR1 of the first alignment film 110 has been subjected to an alignment treatment along a first alignment treatment direction PD1, whereas the second alignment region OR2 has been subjected to an alignment treatment along a second alignment treatment direction PD2 which is different from the first alignment treatment direction PD1. The first alignment treatment direction PD1 is essentially antiparallel to the second alignment treatment direction PD2. Moreover, the third alignment region OR3 of the second alignment film 120 has been subjected to an alignment treatment along a third alignment treatment direction PD3, whereas the fourth alignment region OR4 has been subjected to an alignment treatment along a fourth alignment treatment direction PD4 which is different from the third alignment treatment direction PD3. The third alignment treatment direction PD3 is essentially antiparallel to the fourth alignment treatment direction PD4.

As shown in FIG. 4(c), four liquid crystal domains A, B, C, and D are formed in the liquid crystal layer 260 of a pixel. In the liquid crystal layer 260, a portion interposed between the first alignment region OR1 of the first alignment film 110 and the third alignment region OR3 of the second alignment film 120 defines the liquid crystal domain A; a portion interposed between the first alignment region OR1 of the first alignment film 110 and the fourth alignment region OR4 of the second alignment film 120 defines a liquid crystal domain B; a portion interposed between the second alignment region OR2 of the first alignment film 110 and the fourth alignment region OR4 of the second alignment film 120 defines a liquid crystal domain C; and a portion interposed between the second alignment region OR2 of the first alignment film 110 and the third alignment region OR3 of the second alignment film 120 defines a liquid crystal domain D. Note that the angle constituted by the first or second alignment treatment direction PD1 or PD2 and the third or fourth alignment treatment direction PD3 or PD4 is essentially 90°, and the twist angle in each of the liquid crystal domains A, B, C, and D is essentially 90°.

The alignment direction of a liquid crystal molecule at the center of a liquid crystal domain A to D is an intermediate direction between the pretilt direction for liquid crystal molecules introduced by the first alignment film 110 and the pretilt direction for liquid crystal molecules introduced by the second alignment film 120. In the present specification, the alignment direction of a liquid crystal molecule in the center of a liquid crystal domain is referred to as a reference alignment direction; and within the reference alignment direction, an azimuth angle component in a direction from the rear face toward the front face and along the major axis of the liquid crystal molecule (i.e., an azimuth angle component obtained by projecting the reference alignment direction onto the principal face of the first alignment film 110 or the second alignment film 120) is referred to as a reference alignment azimuth. The reference alignment azimuth characterizes its corresponding liquid crystal domain, and exerts a predominant influence on the viewing angle characteristics of that liquid crystal domain. Now, by relying on the horizontal direction (right-left direction) of the display screen (plane of the figure) as a reference for the azimuthal direction, and defining the left turn as positive (i.e., if the display surface is compared to the face of a clock, counterclockwise is positive, the 3 o'clock direction being an azimuth angle of 0°), the reference alignment directions of the four liquid crystal domains A to D are set to be four directions such that the difference between any two directions is substantially equal to an integer multiple of 90°. Specifically, the reference alignment azimuths of the liquid crystal domains A, B, C, and D are, respectively, 225°, 315°, 45°, and 135°.

As shown in FIG. 4(c), the domain lines DL1 to DL4 are respectively formed in the liquid crystal domains A, B, C, and D. The domain line DL1 is formed in parallel to a portion of an edge EG1 of the pixel electrode 226, whereas the domain line DL2 is formed in parallel to a portion of an edge EG2. Moreover, the domain line DL3 is formed in parallel to a portion of an edge EG3 of the pixel electrode 226, whereas the domain line DL4 is formed in parallel to a portion of an edge EG4. Moreover, a disclination line CL indicated by a broken line is observed in a border region where each of the liquid crystal domains A to D adjoins another liquid crystal domain. The disclination lines CL are dark lines in the aforementioned central portion. The disclination lines CL and the domain lines DL1 to DL4 are continuous, thus resulting in dark lines of a reverse [symbol] shape. Although the dark lines herein are in a reverse [symbol] shape, the dark lines may be in an 8 shape.

Although the above-described liquid crystal display device is of the 4D-RTN mode, the present invention is not limited thereto. The liquid crystal display device may be of the CPA mode.

Hereinafter, alignment films and liquid crystal display devices of the present Examples will be described, in comparison with Comparative Examples and Reference Example.

### EXAMPLES

### Example 1-1

Hereinafter, with reference to FIG. 2 and FIG. 5, an alignment film and a liquid crystal display device of Example 1-1 will be described. The liquid crystal display device of Example 1-1 is of the RTN mode.

First, on a principal face of the first transparent substrate 222, although not shown in the figures, TFTs and wiring lines connected to the TFTs, and an insulating layer and the like were formed, upon which the pixel electrodes 226 were formed. Similarly, on a principal face of the second transparent substrate 242, although not shown in the figures, a colored layer having color filters, and an insulating layer and the like were formed, upon which the counter electrode 246 was formed.

Next, a vertical-alignment type alignment film material was provided. The alignment film material was obtained by, after allowing a polyimide precursor (polyamic acid) having a side chain which contains a cinnamate group to be dissolved in a solvent, adding biphenyldimethacrylate as the polyfunctional monomer. The concentration of biphenyldimethacrylate on the basis of the alignment film material was 10 wt %.

Next, the alignment film material was applied on the pixel electrodes 226, and the solvent was removed to a certain extent through one minute of heating at 90° C. as a first heat treatment (pre-sinter), further followed by 40 minutes of heating at 200° C. as a second heat treatment (full sinter). Through such heat treatment, the polyamic acid was imidized, whereby the polyimide 112 was formed. Also through the heat treatment, biphenyldimethacrylate was polymerized, whereby the polyvinyl compound 114 was formed. In this manner, the first alignment film 110 was formed on the pixel electrodes 226.

Thereafter, obliquely from a 40° direction with respect to the normal direction of a principal face of the first alignment film 110, P-polarized light with a peak wavelength of 330 nm was radiated at 50 mJ/cm², thus performing a photo-alignment treatment. With such light irradiation, the cinnamate group underwent a dimerization reaction, whereby a dimerization site was formed. Similarly, the aforementioned alignment film material was applied to form the second alignment film 120 on the counter electrode 246, and a photo-alignment treatment was performed.

Next, the active matrix substrate 220 and the counter substrate 240 were attached together so that the first alignment film 110 and the second alignment film 120 opposed each other and that the angle between the alignment treatment direction of the first alignment film 110 and the alignment treatment direction of the second alignment film 120 was 90°, and fixed so that the interspace between the active matrix substrate 220 and the counter substrate 240 was about 4 μm.

Next, a nematic liquid crystal material having negative dielectric anisotropy was provided, which was introduced between the active matrix substrate 220 and the counter substrate 240. The liquid crystal material had a dielectric anisotropy Δε of −3, and a birefringence Δn of 0.085.

FIG. 5(a) shows an alignment state of the liquid crystal molecules 262 in the liquid crystal display device of Example 1-1. As shown in FIG. 5(b), the active matrix substrate 220 and the counter substrate 240 were attached together so that the angle between the alignment treatment direction PD1 of the first alignment film 110 and the alignment treatment direction PD3 of the second alignment film 120 was 90°, and the liquid crystal molecules 262 had a twist angle of 90°. Herein, the polarization axis of the polarizer on the active matrix substrate 220 was parallel to the alignment treatment direction of the first alignment film 110, and the polarization axis of the polarizer on the counter substrate 240 was parallel to the alignment treatment direction of the second alignment film 120. The liquid crystal molecules 262 had a pretilt angle of 88°. In this manner, a liquid crystal panel was produced.

Next, the resultant liquid crystal panel was subjected to a power-on test of continuously applying a voltage of 8 V for 50 hours at room temperature, which caused only about 0.1° change in the pretilt angle. After finishing the power-on test, the voltage holding ratio was confirmed to be 99.5% or more, indicative that powering had been sufficiently conducted. A liquid crystal display device having such a liquid crystal panel suffered from almost no image sticking.

The liquid crystal display device of Example 1-1, in which ribs or slits were not provided as in the MVA mode, achieved a high aperture ratio. Since no voltage was applied at the time of polymerization, the liquid crystal display device of Example 1-1 was produced without employing a complex fabrication apparatus.

Although the above description illustrates that the photoreactive functional group causing a photodimerization reaction was a cinnamate group, similar effects were also obtained by using a tolan-type, a coumarin group, or a chalcone group as the photoreactive functional group. Although the above description illustrates that biphenyldimethacrylate was used as the polyfunctional monomer, similar effects were also obtained by using other methacrylates or acrylate-type monomers such as biphenyl diacrylate as the polyfunctional monomer.

### Comparative Example 1

Hereinafter, an alignment film and a liquid crystal display device of Comparative Example 1 will be described. The liquid crystal display device of Comparative Example 1 is of the RTN mode. The alignment film of Comparative Example 1 has a similar construction to that of the alignment film of Example 1-1 except that no polyvinyl compound (specifically, polymerization product of biphenyldimethacrylate) is contained.

First, on a principal face of the first transparent substrate, although not shown in the figures, TFTs and wiring lines connected to the TFTs, and an insulating layer and the like were formed, upon which pixel electrodes were formed. Similarly, on a principal face of the second transparent substrate, although not shown in the figures, a colored layer having color filters, and an insulating layer and the like were formed, upon which the counter electrode was formed.

Next, an alignment film material was provided. The alignment film material was obtained by allowing a polyimide precursor (polyamic acid) having a side chain which contains a cinnamate group to be dissolved in a solvent, but no polyfunctional monomer was mixed.

The alignment film material was applied on the pixel electrodes. Next, the solvent was removed to a certain extent through one minute of heating at 90° C. as the first heat treatment, which was followed by 40 minutes of heating at 200° C. as a second heat treatment. As a result, a first alignment film was formed on the pixel electrode. The polymerization product was not formed in this first alignment film.

Next, obliquely from a 40° direction with respect to the normal direction of a principal face of the first alignment film, P-polarized light with a peak wavelength of 330 nm was radiated at 50 mJ/cm², thus performing a photo-alignment treatment. With such light irradiation, the cinnamate group underwent a dimerization reaction, whereby a dimerization site was formed. Similarly, the aforementioned alignment film material was applied to form a second alignment film on the counter electrode, and a photo-alignment treatment was performed.

Next, the active matrix substrate and the counter substrate were attached together so that the first alignment film and the second alignment film opposed each other and that the angle between the alignment treatment direction of the first alignment film and the alignment treatment direction of the second alignment film was 90°, and fixed so that the interspace between the active matrix substrate and the counter substrate was about 4 μm.

Next, a nematic liquid crystal material having negative dielectric anisotropy was provided, which was introduced between the active matrix substrate and the counter substrate. The liquid crystal material had a dielectric anisotropy Δε of −3, and a birefringence Δn of 0.085. At this point, the liquid crystal molecules were aligned in a manner similar to what was described above with reference to FIG. 5, and the liquid crystal molecules 262 had a pretilt angle of 88°. In this manner, a liquid crystal panel was produced.

Next, the resultant liquid crystal panel was subjected to a power-on test of continuously applying a voltage of 8 V for 50 hours at room temperature, as a result of which the pretilt angle decreased by 0.15°. This is presumably because, since the alignment film did not contain the polymerization product, the side chains of the polyimide in the alignment film had flexibility and were susceptible to the action of the liquid crystal molecules, so that the tilt of the side chains of the alignment film changed due to the action of the tilted liquid crystal molecules while powering was conducted. After finishing the power-on test, the voltage holding ratio was confirmed to be 99.5% or more, indicative that powering had been sufficiently conducted. A liquid crystal display device having such a liquid crystal panel suffered from severe image sticking.

### Reference Example

In Example 1-1, biphenyldimethacrylate was used as the polyfunctional monomer; in Reference Example, another monomer was used instead of biphenyldimethacrylate. However, a liquid crystal display device was produced similarly to Example 1-1 except for changing the polyfunctional monomer.

As the monomer herein, a diacrylate was added which includes a trimethylene chain between a ring structure and a polymerizable functional group, and which is represented by the following rational formula. The molecular weight of this molecule was larger than that of biphenyldimethacrylate.

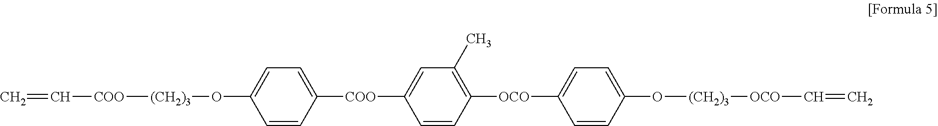

As another monomer, a diacrylate was added which includes a hexamethylene chain between a ring structure and a polymerizable functional group, and which is represented by the following rational formula.

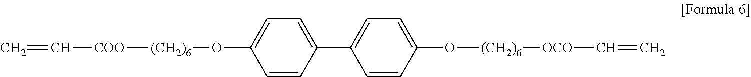

A liquid crystal panel that was produced in a similar manner to Example 1-1 was subjected to a similar power-on test, which revealed that the pretilt angle decreased by 0.15°. As discussed above with respect to Comparative Example 1, this amount of change is similar to that of the case where no monomer was added to the alignment film material. Thus, depending on the monomer added, the polymerization product was not formed in the alignment film, and thus the pretilt angle was not stabilized.

### Example 1-2

Hereinafter, with reference to FIG. 2 and FIG. 5, an alignment film and a liquid crystal display device of Example 1-2 will be described. The liquid crystal display device of Example 1-2 is of the RTN mode.

First, on a principal face of the first transparent substrate 222, although not shown in the figures, TFTs and wiring lines connected to the TFTs, and an insulating layer and the like were formed, upon which the pixel electrodes 226 were formed. Similarly, on a principal face of the second transparent substrate 242, although not shown in the figures, a colored layer having color filters, and an insulating layer and the like were formed, upon which the counter electrode 246 was formed.

A vertical-alignment type alignment film material was provided. The alignment film material was obtained by, after allowing a polyimide precursor (polyamic acid) having a side chain which contains a cinnamate group to be dissolved in a solvent, adding biphenyldimethacrylate. The concentration of biphenyldimethacrylate on the basis of the alignment film material was 10 wt %.

The alignment film material was applied on the pixel electrodes 226, and the solvent was removed to a certain extent through one minute of heating at 90° C., whereby the first alignment film 110 containing polyimide 112 was formed. Thereafter, obliquely from a 40° direction with respect to the normal direction of a principal face of the first alignment film 110, P-polarized light with a peak wavelength of 330 nm was radiated at 50 mJ/cm², thus performing a photo-alignment treatment. With such light irradiation, the cinnamate group underwent a dimerization reaction, whereby a dimerization site was formed. Next, heating was conducted for 40 minutes at 150° C. The biphenyldimethacrylate was polymerized as a result of this, whereby the polyvinyl compound 114 was formed. Similarly to the first alignment film 110, the second alignment film 120 was formed on the counter electrode 246, and a photo-alignment treatment was performed.

Next, the active matrix substrate 220 and the counter substrate 240 were attached together so that the first alignment film 110 and the second alignment film 120 opposed each other and that the angle between the alignment treatment direction PD1 of the first alignment film 110 and the alignment treatment direction PD3 of the second alignment film 120 was 90°, and fixed so that the interspace between the active matrix substrate 220 and the counter substrate 240 was about 4 μm.

Next, a nematic liquid crystal material having negative dielectric anisotropy was provided, which was introduced between the active matrix substrate 220 and the counter substrate 240. The liquid crystal material had a dielectric anisotropy Δε of −3, and a birefringence Δn of 0.085. At this point, the liquid crystal molecules 262 were aligned in a manner similar to what was described above with reference to FIG. 5, and the liquid crystal molecules 262 had a pretilt angle of 87.8°. In the case where the heating temperature after light irradiation was set to 200° C., the liquid crystal molecules 262 had a pretilt angle of 89.9°. In this manner, a liquid crystal panel was produced.

Next, the resultant liquid crystal panel was subjected to a power-on test of continuously applying a voltage of 8 V for 50 hours at room temperature, which caused only about 0.1° change in the pretilt angle. After finishing the power-on test, the voltage holding ratio was confirmed to be 99.5% or more, indicative that powering had been sufficiently conducted. A liquid crystal display device having such a liquid crystal panel suffered from almost no image sticking.

The liquid crystal display device of Example 1-2, in which ribs or slits were not needed as in the MVA mode, achieved a high aperture ratio. Since no voltage was applied at the time of polymerization, the liquid crystal display device of Example 1-2 was produced without employing a complex fabrication apparatus.

Although the above description illustrates that the photoreactive functional group causing a photodimerization reaction was a cinnamate group, similar effects were also obtained by using a tolan-type, a coumarin group, or a chalcone group as the photoreactive functional group. Although the above description illustrates that biphenyldimethacrylate was used as the polyfunctional monomer, similar effects were also obtained by using other methacrylate-type monomers or acrylate-type monomers such as biphenyl diacrylate as the polyfunctional monomer.

### Example 1-3

Hereinafter, with reference to FIG. 2 and FIG. 5, an alignment film and a liquid crystal display device of Example 1-3 will be described. The liquid crystal display device of Example 1-3 is of the RTN mode.

First, on a principal face of the first transparent substrate 222, although not shown in the figures, TFTs and wiring lines connected to the TFTs, and an insulating layer and the like were formed, upon which the pixel electrodes 226 were formed. Similarly, on a principal face of the second transparent substrate 242, although not shown in the figures, a colored layer having color filters, and an insulating layer and the like were formed, upon which the counter electrode 246 was formed.

A vertical-alignment type alignment film material was provided. The alignment film material was obtained by allowing a polyimide precursor (polyamic acid) having a side chain which contains a cinnamate group to be dissolved in a solvent, and adding biphenyldimethacrylate. Herein, a plurality of alignment film materials were provided whose biphenyldimethacrylate concentrations were 5, 10, 20, 30, 40, and 50 wt %, respectively, on the basis of the alignment film material.

The alignment film material was applied on the pixel electrodes 226, and then the solvent was removed to a certain extent through one minute of heating at 90° C., then followed by 40 minutes of heating at 200° C. As a result, the first alignment film 110 containing the polyimide 112 and the polyvinyl compound 114 was formed.

Thereafter, obliquely from a 40° direction with respect to the normal direction of a principal face of the first alignment film 110, P-polarized light with a peak wavelength of 330 nm was radiated at 50 mJ/cm², thus performing a photo-alignment treatment. With such light irradiation, the cinnamate group underwent a dimerization reaction, whereby a dimerization site was formed. Similarly to the first alignment film 110, the second alignment film 120 was formed on the counter electrode 246, and a photo-alignment treatment was performed.

Next, the active matrix substrate 220 and the counter substrate 240 were attached together so that the first alignment film 110 and the second alignment film 120 opposed each other and that the angle between the alignment treatment direction PD1 of the first alignment film 110 and the alignment treatment direction PD3 of the second alignment film 120 was 90°, and fixed so that the interspace between the active matrix substrate 220 and the counter substrate 240 was about 4 μm.

Next, a nematic liquid crystal material having negative dielectric anisotropy was provided, which was introduced between the active matrix substrate 220 and the counter substrate 240. The liquid crystal material had a dielectric anisotropy Δε of −3, and a birefringence Δn of 0.085. At this point, the liquid crystal molecules were aligned in a manner similar to what was described above with reference to FIG. 5, and the liquid crystal molecules 262 had a pretilt angle of 88°. In this manner, a liquid crystal panel was produced.

Next, the resultant liquid crystal panel was subjected to a power-on test of continuously applying a voltage of 8 V for 50 hours at room temperature, which caused only about 0.1° change in the pretilt angle. After finishing the power-on test, the voltage holding ratio was confirmed to be 99.5% or more, indicative that powering had been sufficiently conducted. A liquid crystal display device having such a liquid crystal panel suffered from almost no image sticking.

Although the above description illustrates that the photoreactive functional group causing a photodimerization reaction was a cinnamate group, similar effects were also obtained by using a tolan-type, a coumarin group, or a chalcone group as the photoreactive functional group. Although the above description illustrates that biphenyldimethacrylate was used as the polyfunctional monomer, similar effects were also obtained by using other methacrylate-type monomers or acrylate-type monomers such as biphenyl diacrylate as the polyfunctional monomer.

Moreover, the effect of stabilizing the pretilt angle was obtained even when the concentration of biphenyldimethacrylate on the basis of the alignment film material was 50 wt %. However, a biphenyldimethacrylate concentration of 40 wt % or more resulted in a slightly whitish appearance, and thus such a concentration is considered to be too high. Therefore, the biphenyldimethacrylate concentration is preferably less than 40 wt %. The whitishness was significant when the biphenyldimethacrylate concentration was 50 wt %, and any higher concentration resulted in an observation of a decreased contrast due to scatter. This is presumably because dispersion of biphenyldimethacrylate becomes non-homogeneous when the biphenyldimethacrylate concentration becomes high.

### Example 2

Hereinafter, with reference to FIG. 2 and FIG. 5, an alignment film and a liquid crystal display device of Example 2 will be described. The liquid crystal display device of Example 2 is of the RTN mode.

First, on a principal face of the first transparent substrate 222, although not shown in the figures, TFTs and wiring lines connected to the TFTs, and an insulating layer and the like were formed, upon which the pixel electrodes 226 were formed. Similarly, on a principal face of the second transparent substrate 242, although not shown in the figures, a colored layer having color filters, and an insulating layer and the like were formed, upon which the counter electrode 246 was formed.

A vertical-alignment type alignment film material was provided. The alignment film material was obtained by allowing a polyimide precursor (polyamic acid) to be dissolved in a solvent, and thereafter adding biphenyldimethacrylate. The concentration of biphenyldimethacrylate on the basis of the alignment film material was 10 wt %.

The alignment film material was applied on the pixel electrodes 226, and the solvent was removed to a certain extent through one minute of heating at 90° C., further followed by 40 minutes of heating at 200° C. As a result, the polyimide 112 was formed, and biphenyldimethacrylate was polymerized to form the polyvinyl compound 114. In this manner, the first alignment film 110 was formed on the pixel electrodes 226. Thereafter, the first alignment film 110 was subjected to a rubbing treatment. Similarly to the first alignment film 110, the second alignment film 120 was formed on the counter electrode 246, and subjected to a rubbing treatment.

Next, the active matrix substrate 220 and the counter substrate 240 were attached together so that the first alignment film 110 and the second alignment film 120 opposed each other and that the angle between the alignment treatment direction PD1 of the first alignment film 110 and the alignment treatment direction PD3 of the second alignment film 120 was 90°, and fixed so that the interspace between the active matrix substrate 220 and the counter substrate 240 was about 4 μm.

Next, a nematic liquid crystal material having negative dielectric anisotropy was provided, which was introduced between the active matrix substrate 220 and the counter substrate 240. The liquid crystal material had a dielectric anisotropy Δε of −3, and a birefringence Δn of 0.085. At this point, the liquid crystal molecules were aligned in a manner similar to what was described above with reference to FIG. 5, and the liquid crystal molecules 262 had a pretilt angle of 88°. In this manner, a liquid crystal panel was produced.

Next, the resultant liquid crystal panel was subjected to a power-on test of continuously applying a voltage of 8 V for 50 hours at room temperature, which caused only about 0.1° change in the pretilt angle. After finishing the power-on test, the voltage holding ratio was confirmed to be 99.5% or more, indicative that powering had been sufficiently conducted. A liquid crystal display device having such a liquid crystal panel suffered from almost no image sticking.

The liquid crystal display device of Example 2, in which ribs or slits were not needed as in the MVA mode, achieved a high aperture ratio. Moreover, since no voltage was applied at the time of polymerization, the liquid crystal display device of Example 2 was produced without employing a complex fabrication apparatus.

### Comparative Example 2

An alignment film and a liquid crystal display device of Comparative Example 2 will be described. The liquid crystal display device of Comparative Example 2 is of the RTN mode. The alignment film of Comparative Example 2 has a similar construction to that of the alignment film of Example 2 except that no polyvinyl compound (specifically, polymerization product of biphenyldimethacrylate) is contained.

First, on a principal face of the first transparent substrate, although not shown in the figures, TFTs and wiring lines connected to the TFTs, and an insulating layer and the like were formed, upon which pixel electrodes were formed. Similarly, on a principal face of the second transparent substrate, although not shown in the figures, a colored layer having color filters, and an insulating layer and the like were formed, upon which the counter electrode was formed.

A vertical-alignment type alignment film material was provided. The alignment film material was obtained by allowing a polyimide precursor (polyamic acid) to be dissolved in a solvent. This alignment film material was applied on the pixel electrodes, and the solvent was removed to a certain extent through one minute of heating at 90° C., further followed by 40 minutes of heating at 200° C. As a result, a first alignment film was formed. However, the polymerization product was not formed in the first alignment film. Thereafter, the first alignment film was subjected to a rubbing treatment. Similarly to the first alignment film, a second alignment film was formed on the counter electrode, and was subjected to a rubbing treatment.

Next, the active matrix substrate and the counter substrate were attached together so that the first alignment film and the second alignment film opposed each other and that the angle between the alignment treatment direction of the first alignment film and the alignment treatment direction of the second alignment film was 90°, and fixed so that the interspace between the active matrix substrate and the counter substrate was about 4 μm.

Next, a nematic liquid crystal material having negative dielectric anisotropy was provided, which was introduced between the active matrix substrate and the counter substrate. The liquid crystal material had a dielectric anisotropy Δε of −3, and a birefringence Δn of 0.085. At this point, the liquid crystal molecules were aligned in a manner similar to what was described with reference to FIG. 5, and the liquid crystal molecules had a pretilt angle of 88°. In this manner, a liquid crystal panel was produced.

Next, the resultant liquid crystal panel was subjected to a power-on test of continuously applying a voltage of 8 V for 50 hours at room temperature, as a result of which the pretilt angle decreased by 0.22°. This is presumably because the side chains of the polyimide in the alignment film had flexibility and were susceptible to the action of the liquid crystal molecules, so that the tilt of the side chains of the alignment film changed due to the action of the tilted liquid crystal molecules while powering was conducted. After finishing the power-on test, the voltage holding ratio was confirmed to be 99.5% or more, indicative that powering had been sufficiently conducted. A liquid crystal display device having such a liquid crystal panel suffered from severe image sticking.

### Example 3

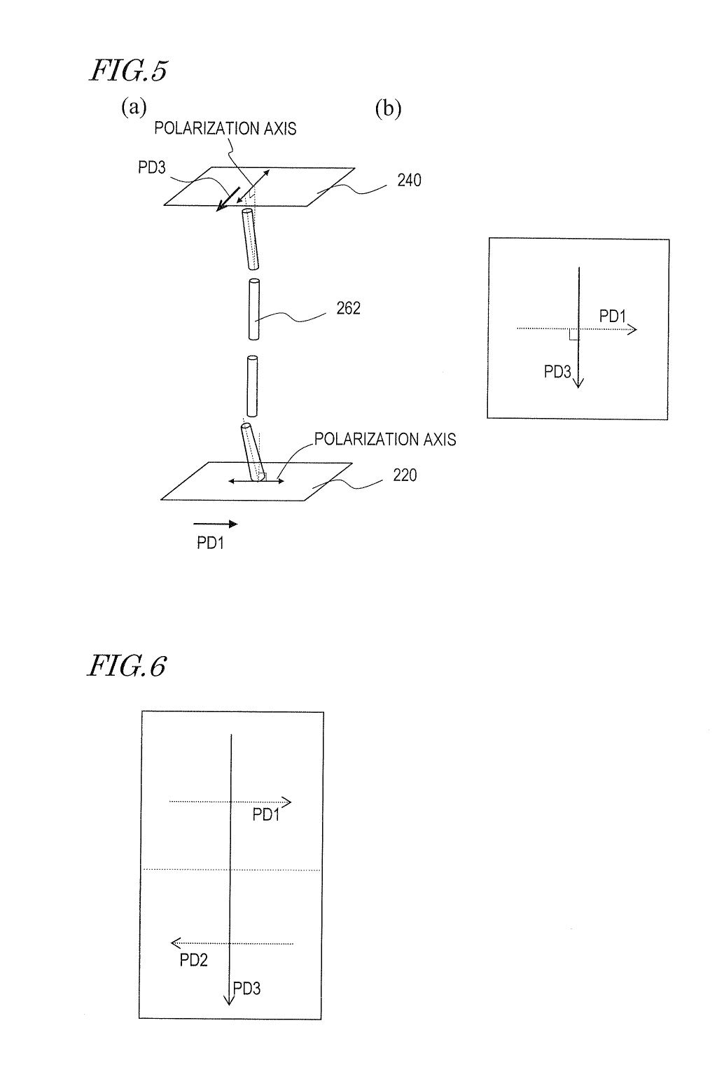

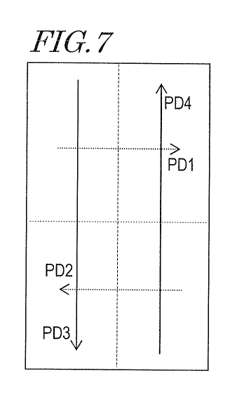

With reference to FIG. 2 and FIG. 6, an alignment film and a liquid crystal display device of Example 3 will be described. The liquid crystal display device of Example 3 is of the RTN mode.

First, on a principal face of the first transparent substrate 222, although not shown in the figures, TFTs and wiring lines connected to the TFTs, and an insulating layer and the like were formed, upon which the pixel electrodes 226 were formed. Similarly, on a principal face of the second transparent substrate 242, although not shown in the figures, a colored layer having color filters, and an insulating layer and the like were formed, upon which the counter electrode 246 was formed.

A vertical-alignment type alignment film material was provided. The alignment film material was obtained by, after allowing a polyimide precursor (polyamic acid) having a side chain which contains a cinnamate group to be dissolved in a solvent, mixing biphenyldimethacrylate. The concentration of biphenyldimethacrylate on the basis of the alignment film material was 10 wt %.

The alignment film material was applied on the pixel electrodes 226, and the solvent was removed to a certain extent through one minute of heating at 90° C., further followed by 40 minutes of heating at 200° C. As a result, the polyimide 112 was formed, and biphenyldimethacrylate was polymerized to form the polyvinyl compound 114. In this manner, the first alignment film 110 was formed on the pixel electrodes 226.

Thereafter, regions of the first alignment film 110 each corresponding to a half of a pixel were irradiated at 50 mJ/cm² with P-polarized light having a peak wavelength of 330 nm, at an azimuth angle of 0° and obliquely from a 40° direction with respect to the normal direction of a principal face of the first alignment film 110. When the light irradiation was performed, the cinnamate group underwent a dimerization reaction, whereby a dimerization site was formed. Next, regions each corresponding to the other half of a pixel of the first alignment film 110 were irradiated at 50 mJ/cm² with P-polarized light having a peak wavelength of 330 nm, at an azimuth angle of 180° and obliquely from a 40° direction with respect to the normal direction of the principal face of the first alignment film 110. Thus, photo-alignment treatments were performed to form regions with different alignment treatment directions.

Similarly, the aforementioned alignment film material was applied on the counter electrode 246, and the solvent was removed to a certain extent through one minute of heating at 90° C., further followed by 40 minutes of heating at 200° C. The polyimide 122 was formed, and biphenyldimethacrylate was polymerized to form the polyvinyl compound 124. In this manner, the second alignment film 120 was formed on the counter electrode 246. Thereafter, each pixel of the second alignment film 120 was irradiated at 50 mJ/cm² with P-polarized light having a peak wavelength of 330 nm, obliquely from a 40° direction with respect to the normal direction of a principal face of the second alignment film 120. Thus, a photo-alignment treatment was performed.

Next, the active matrix substrate 220 and the counter substrate 240 were attached together so that the first alignment film 110 and the second alignment film 120 opposed each other and that the angle between the alignment treatment direction of the first alignment film 110 and the alignment treatment direction of the second alignment film 120 was 90°, and fixed so that the interspace between the active matrix substrate 220 and the counter substrate 240 was about 4 μm.

Next, a nematic liquid crystal material having negative dielectric anisotropy was provided, which was introduced between the active matrix substrate 220 and the counter substrate 240. The liquid crystal material had a dielectric anisotropy Δε of −3, and a birefringence Δn of 0.085.

FIG. 6 shows alignment treatment directions of the first and second alignment films 110 and 120 of Example 3. As described above, the active matrix substrate 220 and the counter substrate 240 were attached together so that the alignment treatment directions PD1 and PD2 of the first alignment film 110 and the alignment treatment direction PD3 of the second alignment film 120 constituted angles of 90°, and the liquid crystal molecules 262 had a twist angle of 90°. At this point, the liquid crystal molecules 262 had a pretilt angle of 88°. In this manner, a liquid crystal panel realizing two-split alignments was produced.

Next, the resultant liquid crystal panel was subjected a power-on test of continuously applying a voltage of 8 V for 50 hours at room temperature, which caused only about 0.1° change in the pretilt angle. After finishing the power-on test, the voltage holding ratio was confirmed to be 99.5% or more, indicative that powering had been sufficiently conducted. A liquid crystal display device having such a liquid crystal panel suffered from almost no image sticking.

The liquid crystal display device of Example 3, in which ribs or slits were not needed as in the MVA mode, achieved a high aperture ratio. Moreover, since no voltage was applied at the time of polymerization, the liquid crystal display device of Example 3 was produced without employing a complex fabrication apparatus.

Although the above description illustrates that the photoreactive functional group causing a photodimerization reaction was a cinnamate group, similar effects were also obtained by using a tolan-type, a coumarin group, or a chalcone group as the photoreactive functional group. Although the above description illustrates that biphenyldimethacrylate was used as the polyfunctional monomer, similar effects were also obtained by using other methacrylate-type monomers or acrylate-type monomers such as biphenyl diacrylate as the polyfunctional monomer.

### Example 4

Hereinafter, with reference to FIG. 2 and FIG. 7, an alignment film and a liquid crystal display device of Example 4 will be described. The liquid crystal display device of Example 4 is of the 4D-RTN mode.

First, on a principal face of the first transparent substrate 222, although not shown in the figures, TFTs and wiring lines connected to the TFTs, and an insulating layer and the like were formed, upon which the pixel electrodes 226 were formed. Similarly, on a principal face of the second transparent substrate 242, although not shown in the figures, a colored layer having color filters, and an insulating layer and the like were formed, upon which the counter electrode 246 was formed.

A vertical-alignment type alignment film material was provided. The alignment film material was obtained by, after allowing a polyimide precursor (polyamic acid) having a side chain which contains a cinnamate group to be dissolved in a solvent, mixing biphenyldimethacrylate. The concentration of biphenyldimethacrylate on the basis of the alignment film material was 10 wt %.

The alignment film material was applied on the pixel electrodes 226, and the solvent was removed to a certain extent through one minute of heating at 90° C., further followed by 40 minutes of heating at 200° C. As a result, the polyimide 112 was formed, and biphenyldimethacrylate was polymerized to form the polyvinyl compound 114. In this manner, the first alignment film 110 was formed on the pixel electrodes 226.

Thereafter, regions of the first alignment film 110 each corresponding to a half of a pixel were 50 mJ/cm² irradiated with P-polarized light having a peak wavelength of 330 nm, at an azimuth angle of 0° and obliquely from a 40° direction with respect to the normal direction of a principal face of the first alignment film 110. When the light irradiation was performed, the cinnamate group underwent a dimerization reaction, whereby a dimerization site was formed. Next, regions each corresponding to the other half of a pixel of the first alignment film 110 were irradiated at 50 mJ/cm² with P-polarized light having a peak wavelength of 330 nm, at an azimuth angle of 180° and obliquely from a 40° direction with respect to the normal direction of the principal face of the first alignment film 110. Thus, photo-alignment treatments were performed to form regions with different alignment treatment directions.

Similarly to the first alignment film 110, the aforementioned alignment film material was applied on the counter electrode 246, and the solvent was removed to a certain extent through one minute of heating at 90° C., further followed by 40 minutes of heating at 200° C. As a result, The polyimide 122 was formed, and biphenyldimethacrylate was polymerized to form the polyvinyl compound 124. In this manner, the second alignment film 120 was formed on the counter electrode 246.

Thereafter, regions of the second alignment film 120 each corresponding to a half of a pixel were 50 mJ/cm² irradiated with P-polarized light having a peak wavelength of 330 nm, at an azimuth angle of 90° and obliquely from a 40° direction with respect to the normal direction of a principal face of the second alignment film 120. When the light irradiation was performed, the cinnamate group underwent a dimerization reaction, whereby a dimerization site was formed. Next, regions of the second alignment film 120 each corresponding to the other half of a pixel were irradiated at 50 mJ/cm² with P-polarized light having a peak wavelength of 330 nm, at an azimuth angle of 270° and obliquely from a 40° direction with respect to the normal direction of the principal face of the second alignment film 120. Thus, photo-alignment treatments were performed to form regions with different alignment treatment directions.

Next, the active matrix substrate 220 and the counter substrate 240 were attached together so that the first alignment film 110 and the second alignment film 120 opposed each other and that the angle between the alignment treatment direction of the first alignment film 110 and the alignment treatment direction of the second alignment film 120 was 90°, and fixed so that the interspace between the active matrix substrate 220 and the counter substrate 240 was about 4 μm.

Next, a nematic liquid crystal material having negative dielectric anisotropy was provided, which was introduced between the active matrix substrate 220 and the counter substrate 240. The liquid crystal material had a dielectric anisotropy Δε of −3, and a birefringence Δn of 0.085.

FIG. 7 shows alignment treatment directions of the first and second alignment films 110 and 120 of Example 4. As described above, the active matrix substrate 220 and the counter substrate 240 were attached together so that the alignment treatment directions PD1 and PD2 of the first alignment film 110 and the alignment treatment directions PD3 and PD4 of the second alignment film 120 constituted angles of 90°, and the liquid crystal molecules 262 had a twist angle of 90°. At this point, the liquid crystal molecules 262 had a pretilt angle of 88°. In this manner, a liquid crystal panel realizing four-split alignments was produced.

Next, the resultant liquid crystal panel was subjected to a power-on test of continuously applying a voltage of 8 V for 50 hours at room temperature, which caused only about 0.1° change in the pretilt angle. After finishing the power-on test, the voltage holding ratio was confirmed to be 99.5% or more, indicative that powering had been sufficiently conducted. A liquid crystal display device having such a liquid crystal panel suffered from almost no image sticking.

Although the above description illustrates that the photoreactive functional group causing a photodimerization reaction was a cinnamate group, similar effects were also obtained by using a tolan-type, a coumarin group, or a chalcone group as the photoreactive functional group. Although the above description illustrates that biphenyldimethacrylate was used as the polyfunctional monomer, similar effects were also obtained by using other methacrylate-type monomers or acrylate-type monomers such as biphenyl diacrylate as the polyfunctional monomer.

The liquid crystal display device of Example 4, in which ribs or slits were not needed as in the MVA mode, achieved a high aperture ratio. Moreover, since no voltage was applied at the time of polymerization, the liquid crystal display device of Example 4 was produced without employing a complex fabrication apparatus.

For reference sake, the entire disclosure of Japanese Patent Application No. 2008-225913, on which the present application claims priority, is incorporated herein by reference.

### INDUSTRIAL APPLICABILITY

An alignment film according to the present invention is able to suppress image sticking caused by changes in the pretilt angle. Moreover, a liquid crystal display device according to the present invention can be easily produced. For example, there is no need to form polymerization product after attaching an active matrix substrate and a counter substrate together, thus providing an increased degree of freedom in terms of production.

### REFERENCE SIGNS LIST

100 first alignment film
102 polyimide
104 polyvinyl compound
110 first alignment film
112 polyimide
114 polyvinyl compound
120 second alignment film
122 polyimide
124 polyvinyl compound
200 liquid crystal display device
210 liquid crystal panel
220 active matrix substrate
222 first transparent substrate
226 pixel electrode
240 counter substrate
242 second transparent substrate
246 counter electrode
260 liquid crystal layer
262 liquid crystal molecule

1. An alignment film comprising polyimide and a polyvinyl compound, wherein, the polyvinyl compound contains a polymerization product of a polyfunctional monomer having a plurality of vinyl groups; and
the polyfunctional monomer is represented by general formula (1) P1-A1-(Z1-A2)n-P2 (in general formula (1), P1 and P2 are, independently, acrylate, methacrylate, acrylamide or methacrylamide; A1 and A2 represent, independently, 1,4-phenylene, 1,4-cyclohexane or 2,5-thiophene, or naphthalene-2,6-diyl, anthracene-2,7-diyl, anthracene-1,8-diyl, anthracene-2,6-diyl or anthracene-1,5-diyl; and Z1 is a —COO— group, a —OCO— group, a —O— group, a —CONH— group or a single bond, where n is 0 or 1).

2. The alignment film of claim 1, wherein each of plurality of vinyl groups of the polyfunctional monomer is a part of a methacrylate group or an acrylate group.

3. The alignment film of claim 1, wherein the polyfunctional monomer has two or more directly-bonded ring structures or one or more condensed ring structures between the plurality of vinyl groups.

4. The alignment film of claim 1, wherein both of the polyimide and the polyvinyl compound are present on a surface and in an interior thereof.

5. The alignment film of claim 4, wherein a concentration of the polyvinyl compound at the surface is higher than a concentration of the polyvinyl compound in the interior.

6. The alignment film of claim 1, wherein the alignment film is a photo-alignment film.

7. The alignment film of claim 6, wherein the polyimide has a side chain containing a photoreactive functional group.

8. The alignment film of claim 7, wherein the photoreactive functional group includes a cinnamate group.

9. A liquid crystal display device comprising an active matrix substrate, a counter substrate, and a liquid crystal layer provided between the active matrix substrate and the counter substrate, wherein
at least one of the active matrix substrate and the counter substrate comprises the alignment film of claim 1.

10. The liquid crystal display device of claim 9, wherein the alignment film regulates liquid crystal molecules in the liquid crystal layer so that the liquid crystal molecules are inclined with respect to a normal direction of a principal face of the alignment film in the absence of an applied voltage.

11. The liquid crystal display device of claim 9, wherein, the liquid crystal display device has a plurality of pixels; and
in each of the plurality of pixels, the liquid crystal layer has a plurality of liquid crystal domains having respectively different reference alignment azimuths.

12. The liquid crystal display device of claim 11, wherein the plurality of liquid crystal domains are four liquid crystal domains.

13. A method of producing an alignment film, comprising the steps of
providing an alignment film material containing a mixture of a polyimide precursor and a polyfunctional monomer having a plurality of vinyl groups; and
forming polyimide from the polyimide precursor, and forming a polyvinyl compound from the polyfunctional monomer.

14. The method of producing an alignment film of claim 13, wherein the step of forming the polyvinyl compound comprises a step of polymerizing the polyfunctional monomer.

15. The method of producing an alignment film of claim 13, wherein, in the step of providing the alignment film material, the polyfunctional monomer has two or more directly-bonded ring structures or one or more condensed ring structures between the plurality of vinyl groups, and a concentration of the polyfunctional monomer on the basis of the alignment film material is in the range of no less than 2 wt % and no more than 50 wt %.

16. The method of producing an alignment film of claim 13, wherein the step of forming the polyimide and the polyvinyl compound comprises a step of performing a heat treatment.

17. The method of producing an alignment film of claim 16, wherein the step of performing a heat treatment comprises the steps of:
performing a first heat treatment; and
after performing the first heat treatment, performing a second heat treatment at a higher temperature than that of the first heat treatment.

18. A method of producing a liquid crystal display device, comprising the steps of:
forming an active matrix substrate and a counter substrate; and
forming a liquid crystal layer between the active matrix substrate and the counter substrate, wherein, the step of forming the active matrix substrate and the counter substrate comprises the steps of:
providing a first transparent substrate having a pixel electrode thereon and a second transparent substrate having a counter electrode thereon; and
producing an alignment film on at least one of the pixel electrode and the counter electrode according to claim 13.

19. The method of producing a liquid crystal display device of claim 18, wherein, in the step of forming the liquid crystal layer, the alignment film, the alignment film regulates liquid crystal molecules in the liquid crystal layer so that the liquid crystal molecules are inclined with respect to a normal direction of a principal face of the alignment film in the absence of an applied voltage.

20. The method of producing a liquid crystal display device of claim 18, wherein the step of forming the active matrix substrate and the counter substrate further comprises a step of performing an alignment treatment for the alignment film.

21. The method of producing a liquid crystal display device of claim 20, wherein the step of performing the alignment treatment further comprises a step of irradiating the alignment film with light.

22. The method of producing a liquid crystal display device of claim 21, wherein the light has a wavelength in the range of no less than 250 nm and no more than 400 nm.

23. The method of producing a liquid crystal display device of claim 21, wherein the step of performing the alignment treatment comprises a step of radiating the light from a direction which is inclined by no less than 5° and no more than 85° with respect to a normal direction of a principal face of the alignment film.

24. The method of producing a liquid crystal display device of claim 21, wherein the light is unpolarized light.

25. The method of producing a liquid crystal display device of claim 21, wherein the light is linearly polarized light, elliptically polarized light, or circularly polarized light.

26. The method of producing a liquid crystal display device of claim 20, wherein the step of performing the alignment treatment comprises a step of performing a rubbing treatment for the alignment film.

27. An alignment film material comprising a polyimide precursor and a polyfunctional monomer having a plurality of vinyl groups.
